(19) United States
(12) Patent Application Publication
(10) Pub. No.: US 2012/0235354 A1
(43) Pub. Date: Sep. 20, 2012

(54) STORYTELLING GAME

(76) Inventor: Itzhak Grinold, Jerusalem (IL)

(21) Appl. No.: 13/505,462

(22) PCT Filed: Mar. 9, 2010
(86) PCT No.: PCT/IB10/51002

§ 371 Date: May 2, 2012

Related U.S. Application Data
(60) Provisional application No. 61/257,864, filed on Nov. 4, 2009.

(51) Int. Cl. A63F 3/00; B31D 1/00

(52) U.S. Cl. 273/239; 273/241; 493/374

(57) ABSTRACT

A game is provided including an attractive cardboard, with folding borders dividing the attractive cardboard into several mutually alignable portions, and removable play pieces attractable to the attractive cardboard and to each other. The attractive cardboard is folded and placed on a substantially horizontal plane such that mutually alignable portions are vertically disposed. The removable play pieces are placed on the vertical portions without falling. The attractive cardboard may include magnets, Velcro or glue. The folding borders divide the cardboard into three portions disposable on a substantially horizontal plane as a room having two adjacent walls and a floor in between. The game may also include a booklet having a plurality of scenarios to be reproduced on the cardboard using the removable play pieces. The game may be implemented as a computerized game over a variety of mobile devices or a personal computer.

### BACKGROUND OF THE INVENTION

1. Field of the Invention

The invention is in the field of box games, especially in board games involving magnetic play pieces to be attached to a cardboard to obtain a three dimensional scenery.

2. Description of Related Art

The present invention is related to two domestic activities, the use of magnetic articles as promotion articles, and as souvenirs on one hand and games which involve both parents and kids.

As promotion articles, magnetic articles are given to people for disposal on iron surfaces, a refrigerator door for example, as paper holder. The message on the article is exposed to people using the refrigerator to the benefit of the business of the article distributer.

Games which support parent-child activity gain much popularity nowadays as they enable parent to participate in the socialization and education of their children. In special, it is important to balance child creativity and parent guidance in such games to get both an interest and enthusiasm of the child and achievement of educational targets, as well as improved cognitive capabilities and skills.

Thus, there is a need for new games that support creativity, activity and educational targets.

### BRIEF SUMMARY OF THE INVENTION

It is provided according to some embodiments of the present invention, a game which includes an attractive cardboard, folding borders dividing the attractive cardboard to several mutually alignable portions, and removable play pieces attractable to the attractive cardboard and to other removable play pieces. The attractive cardboard is folded and placed on an substantially horizontal plane such that at least one of the mutually alignable portions is vertically disposed. The removable play pieces are placed on the vertical portion without falling downward despite gravitation.

In some embodiments, the attractive cardboard includes magnetically attractive substrate embedded in the cardboard.

In some embodiments, attraction of the attractive cardboard is provided by Velcro elements disposed appropriately on the attractive cardboard and on the removable play pieces, or by multiply recurring glue disposed thereof.

In some embodiments, background drawing compatible with the removable play pieces is printed on the cardboard.

In some embodiments, the folding borders divide the cardboard to three portions disposable on a substantially horizontal plane as a room having two adjacent walls and a floor in between.

In some embodiments, the game includes 10 or more flat removable play pieces, preferably 30 or more pieces.

In some embodiments, the game includes flat removable play pieces of width larger than 5 mm.

In some embodiments, the game further includes a booklet having a plurality of scenarios to be reproduced on the cardboard using the removable play pieces. Preferably, the booklet presents more than 12 scenarios.

It is provided by some embodiments of the present invention, a cardboard which includes magnetically attractive substrate elements, and folding borders dividing the attractive cardboard to several mutually alignable portions. The magnetically attractive substrate elements are embedded in the cardboard such that most of the cardboard is magnetically attractive for magnetically attracted removable pieces.

Any two mutually alignable portions have a minimal angle in between. Preferably, the minimal angle is larger than 5°. The attractive cardboard is folded, and is placed on a substantially horizontal plane such that at least one alignable portion is vertically disposed. The removable magnetically attracted pieces are placed on the vertical portion without falling downward despite gravitation.

In some embodiments, the cardboard has areas magnetized in substantially non-parallel directions of polarization.

It is provided according to some embodiments of the current invention, a method for assembling game scenarios. The method includes providing a game, folding an attractive foldable cardboard, disposing the folded attractive cardboard on a substantially horizontal plane such that an alignable portion becomes vertically disposed relative to the horizontal plane, and placing removable play pieces on the vertical portion, and attaching play pieces to other play pieces such that a desired game scenario is assembled.

The provided game includes the attractive cardboard, folding borders dividing the attractive cardboard to two or more mutually alignable portions, and removable play pieces attractable to the attractive cardboard and to each another.

In some embodiments, the game is implemented in a virtual environment on a computerized device. Mutually attracting game parts are stuck together automatically after being brought within a predetermined distance.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a illustrates an attractive cardboard having a folding line dividing the cardboard to two mutually alignable portions.

FIG. 1b is a respective front view of the attractive cardboard vertically disposed on a horizontal plane.

FIG. 2 presents a plurality of removable magnetically attractive play pieces.

FIG. 3 is a typical scenario of a plurality of scenarios in a booklet for guiding use of the game.

FIG. 4 presents a cardboard portion with overlaid play pieces, constituting a realistic scenario in accordance with a typical scenario of the booklet.

FIG. 5a illustrates an attractive cardboard having two folding lines dividing the cardboard to three mutually alignable portions.

FIG. 5b is a respective front view of the attractive cardboard disposed on a horizontal plane.

FIG. 6 is a flow chart of a method for assembling game scenarios.

### DETAILED DESCRIPTION OF THE INVENTION

The present invention will now be described in terns of specific example embodiments. It is to be understood that the invention is not limited to the example embodiments disclosed. It should also be understood that not every feature of the methods and systems handling the described game is necessary to implement the invention as claimed in any particular one of the appended claims. Various elements and features of the game are described to fully enable the invention.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

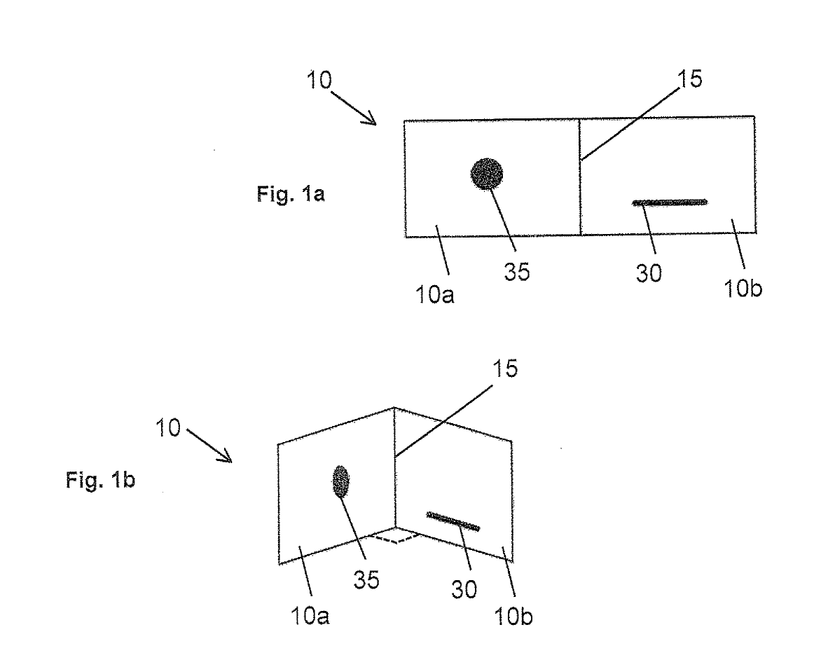

A game which enable assembling a three dimensional scenery is provided by the present invention. The game may be played by parents playing actively with their kids, simulating three-dimensional scenarios, illustrated in a booklet provided with the game. The game includes an attractive cardboard 10 having folding border 15 which divide the attractive cardboard to mutually alignable portions 10a and 10b, as illustrated in FIG. 1. To demonstrate the three dimensional characteristics of the game, thick line segment 30 and disk 35 are drawn on portions 10b and 10a, respectively. The folding border is provided by making a recess along border 15, for example. FIG. 1b depicts cardboard 10 in a folded state, placed on an horizontal surface, floor or table top for example such that two mutually alignable portions 10a and 10b are vertically disposed relative to the horizontal surface, and may be also in substantially right angle relative to one another, like two adjacent walls of a room.

Looking from the front at vertically disposed cardboard 10, disk 35 narrows while keeping its height, and similarly thick line segment 30 shortens, as shown in the respective front view of FIG. 1b. Generally speaking, folded cardboard 10 looks differently from different viewing direction, a feature characterizing a three dimensional scenery.

The game also includes removable play pieces attractable to attractive cardboard 10 and to each other. The removable play pieces may be placed on a vertical portion 10a or 10b without falling downward despite gravitation. Furthermore, due to the mutual attraction between play pieces and due to the attractiveness of cardboard 10, the player may dispose one play piece on another, and the attraction is sufficient to hold the pieces assembly connected to cardboard 10 despite gravitation. Such a strong attraction is provided by magnetically attractive substrate embedded in the cardboard. Note that in the usual domestic application of magnetic articles which are disposed on iron surfaces like a refrigerator door, the iron surface is not an active magnet and the attraction is provided by the magnetic article. One may dispose one magnetic article on another but the gravitational downward force increases with weight and finally overcomes the attraction to the iron surface, and magnetic articles fall down. In contrast, the magnetic board may be made to attract magnetic articles much stronger, and as a result one may pile more magnetic articles on the cardboard and one on another without falling down.

In some embodiments, attraction of attractive cardboard 10 is provided by Velcro elements disposed appropriately on the attractive cardboard and on the removable play pieces, or by multiply recurring glue disposed thereof.

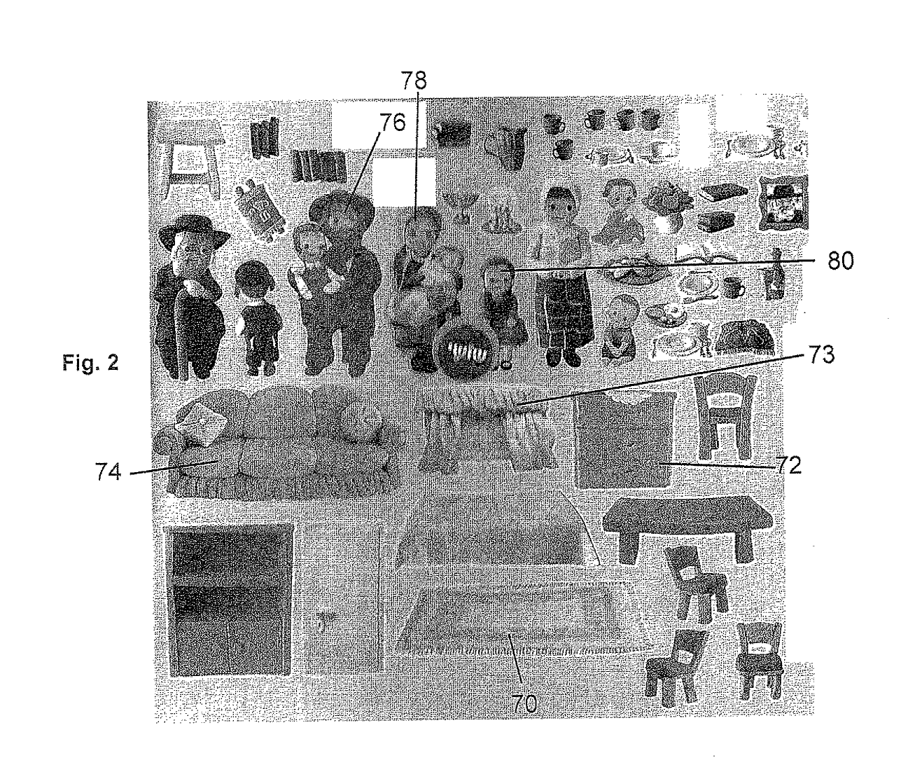

The game may include more than 10 flat removable play pieces, preferably more than 30 pieces as in FIG. 2. in the example of FIG. 2, the play pieces are house furniture and constructive items, as well as human images typical to ultra-orthodox Jewish family. The house items include a carpet 70, a chest 72, a window setting 73, and a sofa 74. The human images include a sitting father 76 holding a boy on his knee, a sitting grandmother 78 holding a baby, a girl 80, a standing grandfather, and a standing boy.

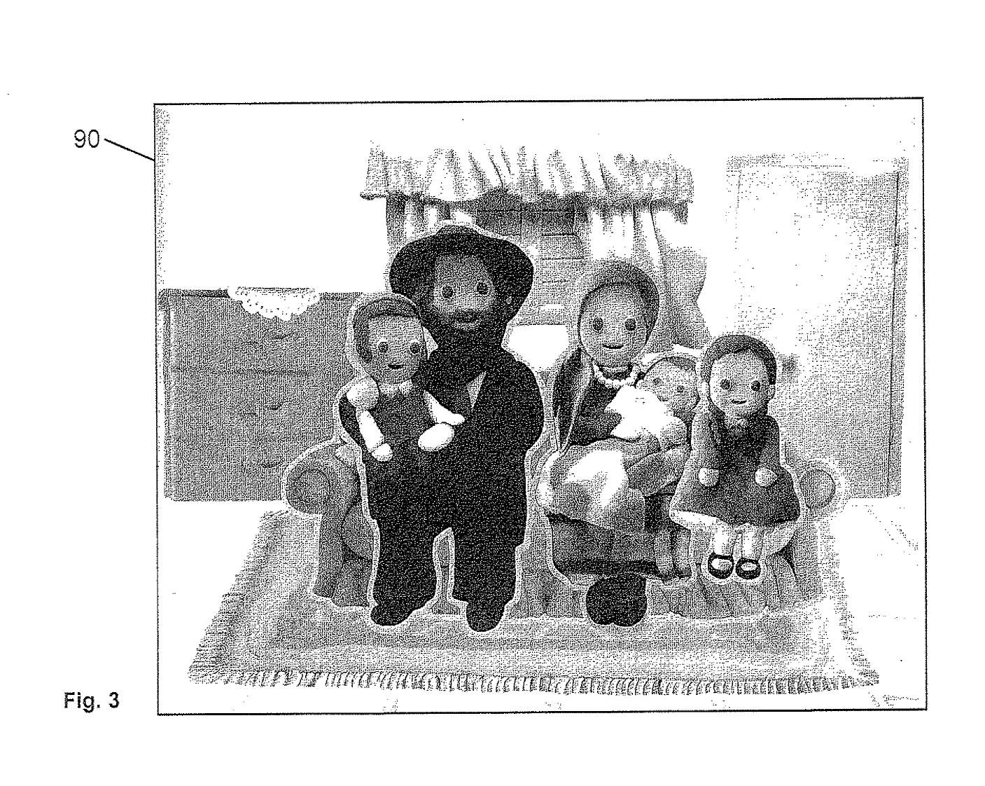

The game includes a booklet having a plurality of scenarios, scenario 90 of FIG. 3, for example. Preferably, the booklet include more than 12 scenarios compatible with the given set of play pieces such that the scenarios may be reproduced on cardboard 10 using the play pieces while a parent or a grown up sibling is playing with a small kid.

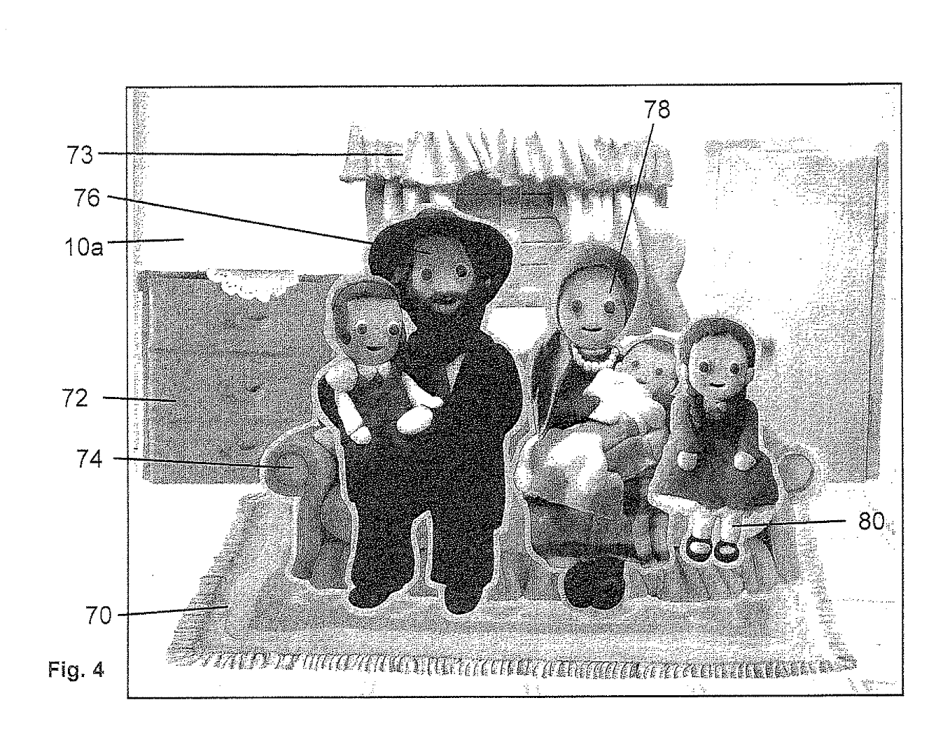

In the example of FIG. 4, cardboard 10 is disposed on a horizontal plane and cardboard portion 10a is used to build scenario 90. First, carpet 70, chest 72 and window-setting 73 are placed on cardboard portion 10a. Then, sofa 74 is disposed on carpet 70. Finally, father 76, grandmother 78 and girl 80 take their places on sofa 74. Thus, a typical family scene similar to scenario 90 is assembled by the players, whereas during the assembly process, a parent may tell an appropriate story to a kid in an interactive and involved way.

Let alone the scenarios provided in the booklet, the plurality and variety of play pieces enable assembling infinite number of additional sceneries, as led by the players imagination and based on the available scenarios to some extent or to no extent.

Note that since play pieces are disposed on one another, the resulted scenery has some depth even if it is build on only one cardboard portion. Such a depth give the observer some sense of a three dimensional scenery. Moreover, a more complex scenario or two scenarios out of the booklet scenarios may be assembled on portions 10a and 10b simultaneously, providing a realistic three dimensional scenery. Also, some flat removable play pieces may be made with width larger than 5 mm, such that they seen differently from different viewing directions, enhancing the three dimensionality character of the game.

In some embodiments, background drawing compatible with the removable play pieces is printed on cardboard 10. For example, a window setting similar to window setting 73 may be printed on cardboard 10a.

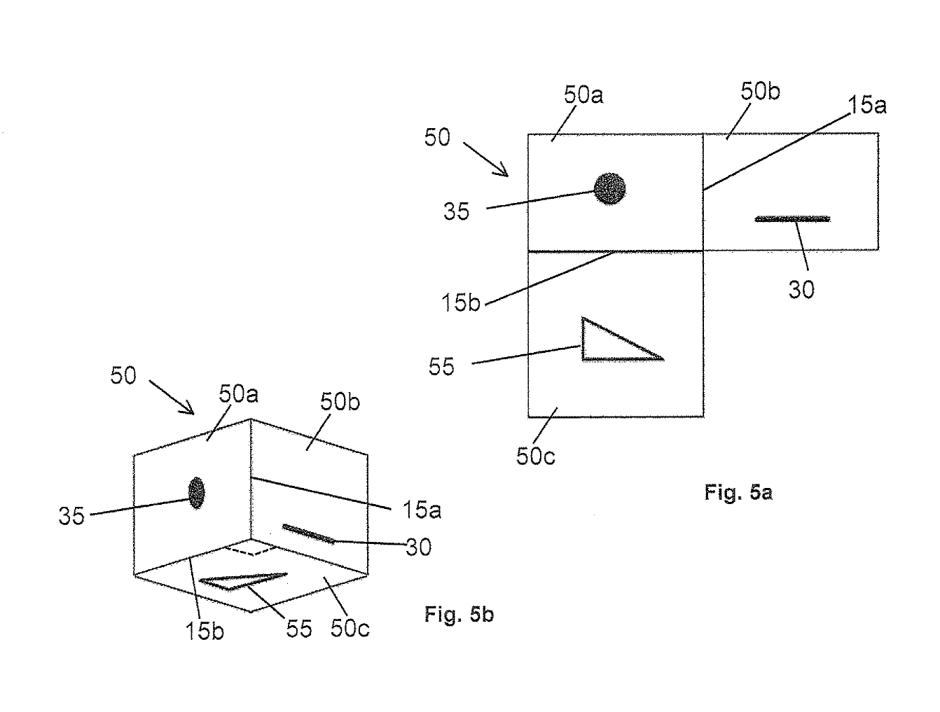

Referring now to cardboard 50 of FIGS. 5a and 5b, folding borders 15a and 15b divide cardboard 50 to three portions 50a, 50b and 50c. Cardboard 50 is folded using borders 15a and 15b, such that portion 50c is placed on an horizontal plane, simulating a floor of a room, while portions 50a and 50b are disposed in right angles to one another and to portion 50c. Thus, a player has a whole room to play with, easily accessed from the open front side.

A cardboard 10 which includes magnetically attractive substrate elements, and has folding borders dividing the attractive cardboard to several mutually alignable portions, may be useful for other games and other applications as detailed below. The magnetically attractive substrate elements are embedded in cardboard such that most of the cardboard is magnetically attractive for magnetically attracted removable pieces.

Cardboard 10 may be used as part of theater decoration, both conventional human theater and puppet or marionette theater. Also, cardboard 10 may be useful in creation of an animation movie, or as a dynamically varying background of an internet site. For example, the internet site may incorporate a camera capturing a dynamic scene changing by replacing and relocating a variety of images on the cardboard.

In some embodiments, the cardboard has areas magnetized in substantially non-parallel directions of polarization, as described in U.S. Pat. No. 6,217,405 to Burrows, which is incorporated by reference for all purposes as if fully set forth herein.

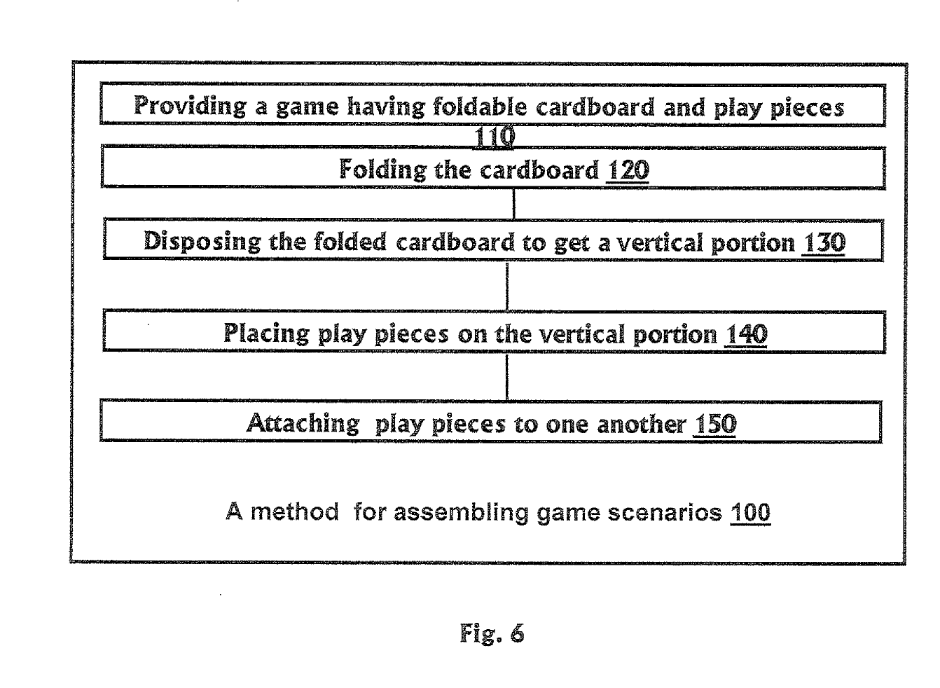

Referring now to FIG. 6, it presents a flow chart of a method 100 for assembling game scenarios. The method includes step 110 of providing a game, step 120 of folding an attractive foldable cardboard, step 130 of disposing the folded attractive cardboard on a substantially horizontal plane such that an alignable portion becomes vertically disposed relative to the horizontal plane, step 140 of placing removable play pieces on the vertical portion, and step 150 of attaching play pieces to other play pieces such that a desired game scenario is assembled.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A game comprising:
(a) at least one attractive cardboard;
(b) one or more folding borders dividing the attractive cardboard to two or more mutually alignable portions; and
(c) a plurality of removable play pieces attractable to the attractive cardboard and to at least another of the removable play pieces,
whereby the attractive cardboard being folded, being placed on a substantially horizontal plane such that at least one of said mutually alignable portions being vertically disposed relative to the horizontal plane, and the removable play pieces being placed on the vertical portion and one on another one without falling downward despite gravitation.

2. The game of claim 1 wherein attraction of the attractive cardboard is provided by magnetically attractive substrate embedded in the cardboard.

3. The game of claim 1 wherein attraction of the attractive cardboard is provided by Velcro elements disposed appropriately on the attractive cardboard and on said plurality of removable play pieces.

4. The game of claim 1 wherein attraction of the attractive cardboard is provided by multiply recurring glue.

5. The game of claim 1 wherein at least one background drawing compatible with one or more of the removable play pieces is printed on the cardboard.

6. The game of claim 1 wherein the folding borders divide the cardboard to three portions disposable on a substantially horizontal plane as a room having two adjacent walls and a floor in between.

7. The game of claim 1 wherein the game includes 10 or more flat removable play pieces.

8. The game of claim 7 wherein the game includes 30 or more flat removable play pieces.

9. The game of claim 1 wherein the game includes at least one flat removable play piece of width larger than 5 mm.

10. The game of claim 1 wherein the game further includes a booklet having a plurality of scenarios, major part of the scenarios are able to be reproduced on the cardboard using pieces of said plurality of removable play pieces.

11. The game of claim 10 wherein the booklet has 12 or more scenarios.

12. A cardboard comprising:
(a) one or more magnetically attractive substrate elements embedded in the cardboard such that a major part of the cardboard being magnetically attractive for magnetically attracted removable pieces;
(b) one or more folding borders dividing the attractive cardboard to two or more mutually alignable portions; and
(c) any two of said two or more mutually alignable portions having a minimal angle in between, said minimal angle being larger than 5°,
whereby the attractive cardboard being folded, being placed on a substantially horizontal plane such that at least one of said mutually alignable portions being vertically disposed, and one or more removable magnetically attracted pieces being placed on the vertical portion without falling downward despite gravitation.

13. The cardboard of claim 10 wherein the cardboard has at least two areas magnetized in substantially non-parallel directions of polarization.

14. A game including the cardboard of claim 12, the game further includes a plurality of removable play pieces attractable to the attractive cardboard and to at least another of the removable play pieces.

15. The game of claim 14 wherein the game further includes a booklet having a plurality of scenarios, whereas major part of the scenarios are able to be reproduced on the cardboard using pieces of said plurality of removable play pieces.

16. A method for assembling game scenarios, the method comprising:
(a) providing a game including:
(i) at least one attractive cardboard;
(ii) one or more folding borders dividing the attractive cardboard to two or more mutually alignable portions; and
(iii) a plurality of removable play pieces attractable to the attractive cardboard and to at least another of the removable play pieces; and
(b) folding at least one of said at least one attractive cardboard;
(c) disposing the folded attractive cardboard on a substantially horizontal plane such that at least one of said mutually alignable portions being vertically disposed relative to the horizontal plane;
(d) placing one or more of said removable play pieces on the vertical portion, whereby play pieces being placed on other play pieces such that a desired game scenario being assembled.

17. The method of claim 16 wherein the game further includes:
(e) attaching at least one play piece to at least another play piece such that the play pieces are attracted to each other.

18. The method of claim 16 wherein the provided game further includes a booklet having a plurality of scenarios, major part of the scenarios are able to be reproduced on the cardboard using pieces of said plurality of removable play pieces, whereby said placing reproduces one of the scenarios.

19. The method of claim 16 wherein the game is implemented in a virtual environment on a computerized device, and mutually attracting game parts are stuck together automatically after being brought within a predetermined distance.
